(19) United States
(12) Patent Application Publication
(10) Pub. No.: US 2010/0043320 A1
(43) Pub. Date: Feb. 25, 2010

(54) WINDOW MOLDING ASSEMBLY AND METHOD OF INSTALLING

(76) Inventor: Matthew W. Gaus, St. George, UT (US)

Correspondence Address: MORRISS OBRYANT COMPAGNI, P.C., 734 EAST 200 SOUTH, SALT LAKE CITY, UT, 84102, US

(21) Appl. No.: 12/507,207

(22) Filed: Jul. 22, 2009

Related U.S. Application Data
(60) Provisional application No. 61/084,211, filed on Jul. 28, 2008.

(51) Int. Cl. E06B 1/04; E06B 3/26; E04G 21/00; E06B 1/70

(52) U.S. Cl. 52/204.5; 52/745.16

(57) ABSTRACT

A window molding assembly comprises a box frame having a right side, left side, top side and window sill. The box frame is configured to fit with an opening of an existing window opening with a portion of the window sill extending from the window opening. A plurality of decorative molding pieces are attached to the front of box frame and extending laterally therefrom a decorative front fascia to cover a front edge of the window opening.

### CROSS-REFERENCE TO RELATED APPLICATION

The present invention claims priority to U.S. Provisional Patent Application 61,084,211 filed on Jul. 28, 2008, to Matthew W. Gaus, the entirety of which is incorporated by this reference.

### FIELD OF THE INVENTION

The present invention relates generally to window moldings, and more specifically, to a preassembled window molding and method of installing such a window molding assembly.

### BACKGROUND OF THE INVENTION

In new home construction and preexisting home remodel, it is common in the art to use various wood-based framing materials to frame in and add decorative wood trim on the interior of the home's windows. In home construction and remodel, it is most often the case that the window opening must be finished after window installation prior to adding any decorative moldings. In order to add any decorative wood trim to such window openings, framing materials and wood trim pieces are cut and installed at the site. Thus, such work is typically reserved to skilled carpenters as it is time consuming as well as labor intensive and thus relatively expensive.

A typical window opening in a frame constructed home is defined by sections of framing materials, such as 2×4 or 2×6 planks. The planks are arranged to form a rectangle to which a window is mounted. When SHEET ROCK wall board is used as the finishing material, the wall board is cut to fit within the window opening with the edges finished to meet with the wall board forming the surrounding interior wall. All corners are covered with a layer of spackle, sanded and painted. If a more decorative window opening is desired, various pieces of wood trim are cut and installed to the inside and surrounding edges of the window opening. Such wood pieces are typically cut on-site using various hand tools. As such the tolerances associated with hand-made moldings vary from molding to molding and are dependent upon the skill of the installer. Typically, either after cutting or after installation such wood pieces need to be sanded, stained and varnished. Accordingly, while it may be desirable to add custom window moldings, the cost associated with such work often makes such window moldings a luxury item that is not within the budget of many home owners.

Accordingly, there is a need in the art to provide a preassembled window molding assembly to provide a custom molding appearance to a window opening that can be installed in any finished or unfinished window opening. Such a preassembled window molding assembly will save significant time in the installation process. In addition, there is a need in the art to provide a preassembled window molding assembly that is less expensive than on-site manufactured and installed window moldings. There is a further need to provide a window molding assembly wherein the molding assembly has relatively tight tolerances as to its dimensions.

### SUMMARY OF THE INVENTION

In accordance with the invention, there is provided a window molding assembly that includes a box frame having a right side, left side, top side and window sill, the right side, left side, top side and a portion of the window sill configured to fit within a window opening. A plurality of decorative molding pieces are attached to the front of the right side, left side and top side and extending outwardly therefrom in a lateral direction to form a front fascia to cover a front edge of a window opening.

In an alternative embodiment, the window sill comprises a first more narrow portion that is configured to fit within the window opening adjacent a bottom thereof and a second wider portion that is wider than the window opening adjacent the bottom of the window opening that extends laterally from the window opening on both sides thereof.

In another embodiment, the front fascia is comprised of left and right vertical side members and a horizontal top member extending to and between said left and right vertical side members, an opening defined by said front fascia being approximately equal to an opening defined by said box frame.

In still another embodiment, a shutter assembly is attached to the fascia. The shutter assembly substantially covers an opening defined by the front fascia.

In yet another embodiment, the box frame is sized to just fit within the window opening where the window opening is not square and the box frame is substantially precisely square.

In another embodiment, the window opening is an unfinished window opening.

In still another embodiment, the left side, right side, top side and window sill have widths that substantially match a depth of a window opening so that the box frame resides entirely within said window opening.

In another embodiment, each inside edge of each of the left side, right side, top side and sill is adjacent to a frame of an associated window when installed therein.

The present invention also includes a method of installing a window molding assembly according to the present invention. The method includes providing the window molding assembly and inserting the box frame into an interior window opening. The window molding assembly is then attached to the interior window opening.

The window molding assembly may be removably attached to the window opening.

To customize the size of the window molding assembly, the height, width and depth of a window opening are measured.

The box frame is formed based on the measured sizes so that the box frame will just fit within the window opening. The window molding assembly is formed to be substantially precisely square event when the measured window opening is not. In addition, the window molding assembly can be installed in an unfinished window opening.

The box frame is sized to substantially match a depth of the window opening so that the box frame resides entirely within the window opening. In addition, the inside edge of the box frame is configured to be adjacent to a frame of an associated window.

In another embodiment, a shutter assembly sized to substantially match an opening defined by the box frame and is attached to a front fascia of the window molding assembly.

### BRIEF DESCRIPTION OF THE DRAWINGS

The foregoing summary, as well as the following detailed description of the illustrated embodiments is better understood when read in conjunction with the appended drawings. For the purpose of illustrating the invention, there is shown in the drawings embodiments that illustrate what is currently considered to be the best mode for carrying out the invention, it being understood, however, that the invention is not limited to the specific methods and instruments disclosed.

FIG. 1 is a front perspective view of a first embodiment of a window molding assembly according the principles of the present invention.

FIG. 2 is an exploded, front perspective view of a first embodiment of a box frame for a window molding assembly according to the principles of the present invention.

FIG. 3 is a partial, exploded, front perspective view of the box frame illustrated in FIG. 2.

FIG. 4 is a front perspective view of the box frame illustrated in FIGS. 2 and 3.

FIG. 5 is a front perspective view of the box frame of FIGS. 2, 3 and 4 with a decorative front fascia attached thereto.

FIG. 6 is a partial cross-sectional side view of a second embodiment of a window molding assembly according to the principles of the present invention attached to a window opening of an interior window.

FIGS. 7A and 7B are front views of a third embodiment of a window molding assembly according to the principles of the present invention.

FIGS. 8A and 8B are front views of a fourth embodiment of a window molding assembly according to the principles of the present invention.

FIGS. 9A and 9B are front views of a fifth embodiment of a window molding assembly according to the principles of the present invention.

### DETAILED DESCRIPTION OF THE ILLUSTRATED EMBODIMENTS

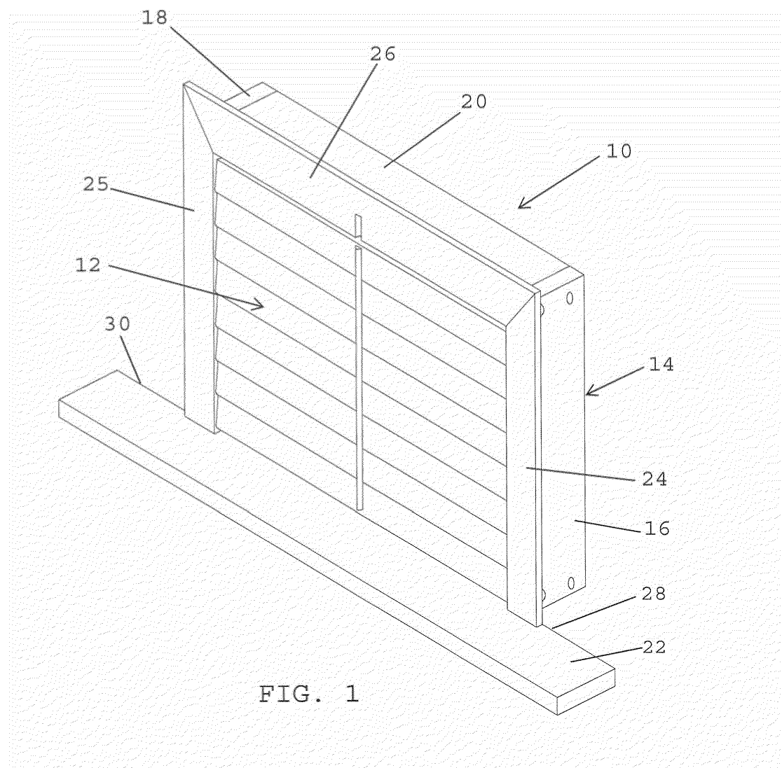

Referring to the drawings, FIG. 1 is a window molding assembly, generally indicated at 10, in accordance with the principles of the present invention. The window molding assembly 10 is configured to be preassembled as shown so as to aid ease of installation. In addition, the window molding assembly 10 may be provided complete with a particular window treatment, such as wood shutters 12. Accordingly, once the window molding assembly 10 according to the principles of the present invention is installed, the window opening is completely finished.

The window molding assembly 10 includes a box frame jamb 14 that includes a right side jamb 16, a left side jamb 18, a top side or head jamb 20 and a window sill 22. Each piece may be form from medium density fiber board, or any wood species, depending on the desired look of the finished product. The thickness of each piece may be ½ inch, ⅝ inch, ¾ inch, 1 inch, or any other desired thickness. The width and height of the pieces, and in particular the outside dimensions of the box frame jam 4, are generally dictated by the particular window opening to which the assembly 10 of the present invention is to be installed. The right side 16, left side 18, top side 20 and a portion (not visible) of the window sill 22 is configured to fit within a window opening (as will be described in more detail). Thus, the outer dimensions of the box frame 14 are such that the box frame 14 will just fit within a particular window opening.

Attached to the front faces of the right side 16, left side 18 and top side 20 are molding pieces 24, 25 and 26, respectively. The molding pieces 24, 25 and 26 define outer dimensions that are wider than those of the box frame 14. That is, a portion of each molding piece 24, 25 and 26 laterally extends outwardly from the box frame 14. The inside surfaces of the molding pieces 24, 25 and 26, as well as the inside edges 28 and 30 of the window sill 22 form abutment surfaces that are pressed against the wall surrounding the window opening (as will be described in more detail). The molding pieces 24, 25 and 26 also cover any unfinished edges of the window opening such that the window opening does not need to be finished. That is, in traditional construction, each window opening is framed, typically with SHEET ROCK wall board. Subsequently, a corner bead is installed and the opening is taped, mudded and sanded until the surface is made smooth for painting. With the window molding assembly 10 of the present invention, such finish work can be completely avoided since the window molding assembly 10 is configured to completely cover the inner surfaces and exposed edges of the window opening. So long as the adjacent interior wall is finished to a point just behind the molding pieces 24, 25 and 26, once installed the window molding assembly 10 provides a completely finished and custom-looking window opening.

It should be noted that the molding pieces 24, 25 and 26 have been illustrated as simple flat stock with mitered corners. It is noted, however, (as shown in Appendix A attached hereto), that various molding pieces 24, 25 and 26 may be more decorative in nature and include many more molding pieces to provide a more elaborate molding configuration. Such additional ornamentation allows the window molding assembly 10 of the present invention to be ornamentally customized by the manufacturer in many different ways to provide a customized appearance in a prefabricated product.

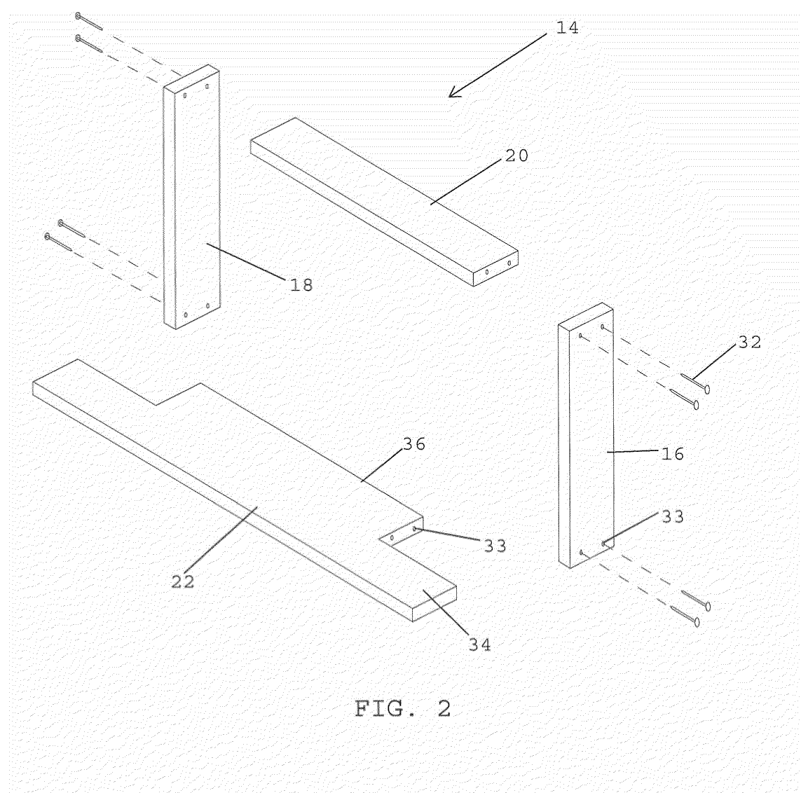

As shown in FIG. 2, the box frame 14 is comprised of the right side jamb 16, left side jamb 18, top side jamb 20 and window sill 22. Each piece is cut to length and width for the particular window opening. The pieces are fastened together, as with fasteners 32, which may be nails or screws such as 18 gauge nails having a 1 ½ inch length. Holes 33 may be predrilled into the various pieces to facilitate attachment with fasteners. An adhesive, such as Confirmat may also be used to help join the pieces together. The window sill 22 has a generally “T-shaped” configuration that includes a wider portion 34 that extends a length wider than a window opening and a narrower portion 36 that is sized to fit between the right side 16 and left side 18 when assembled.

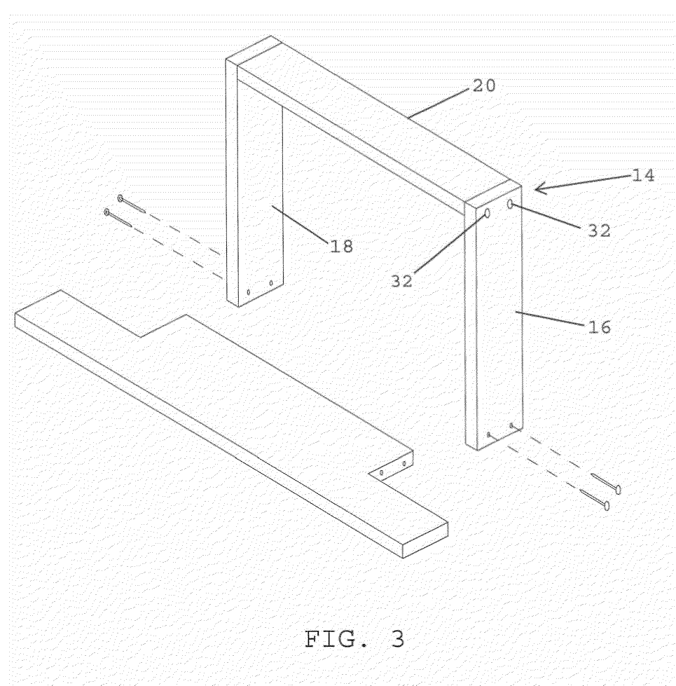

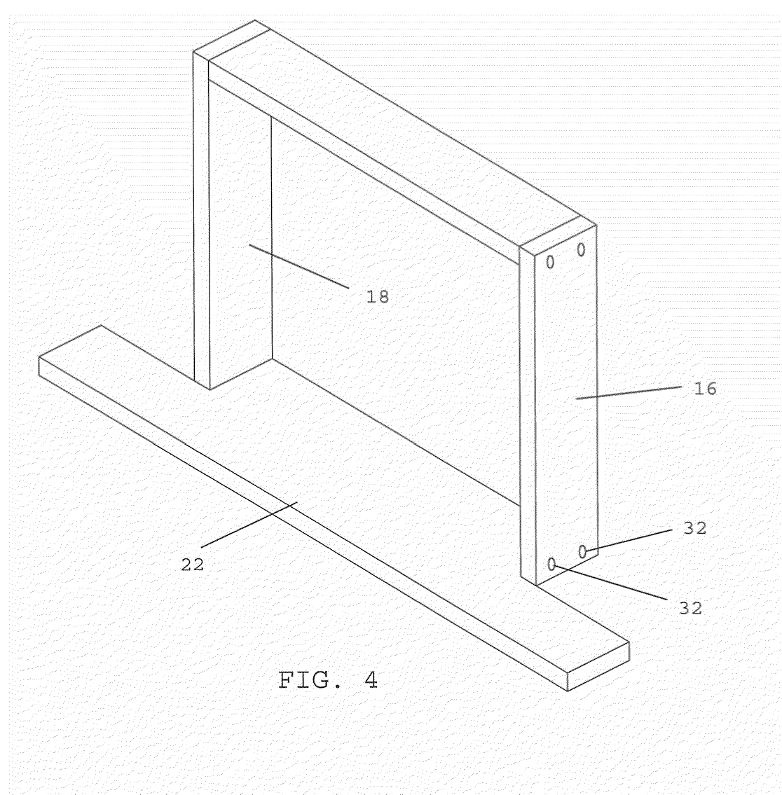

In order to assemble the box frame 14, as shown in FIG. 3, the right side 16 and left side 18 is joined to the top side 20 with fasteners 32. Next, as shown in FIG. 4, the window sill 22 is joined to the right side 16 and left side 18 with fasteners 32.

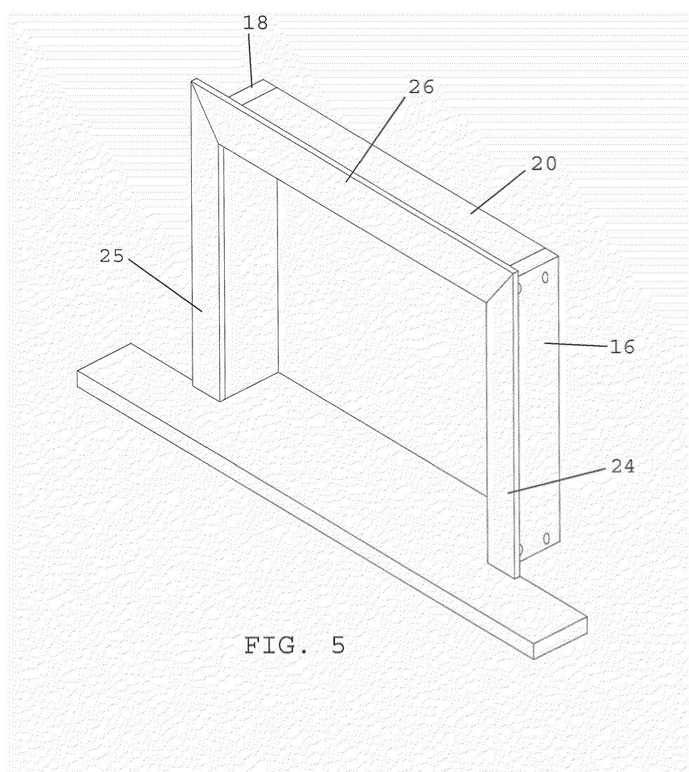

As shown in FIG. 5, decorative molding pieces 24, 25 and 26 are attached to the front edges of the right, left and top sides 16, 18 and 20, respectively. The molding pieces 24, 25 and 26 may be attached with small brads, finishing nails or an adhesive.

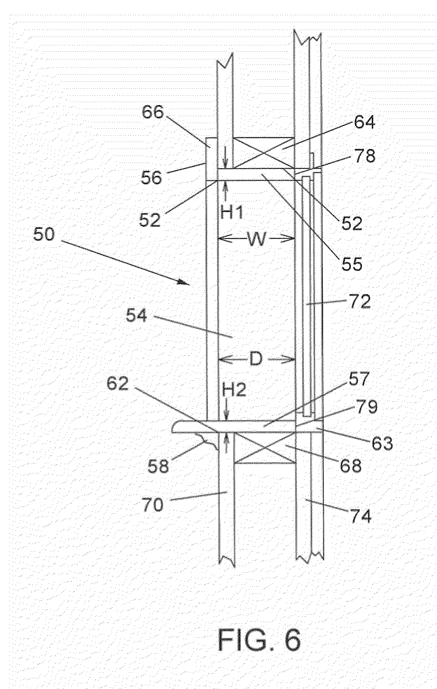

Referring now to FIG. 6, there is illustrated a cross-sectional view of a window molding assembly, generally indicated at 50, installed within a window opening 52 in accordance with the principles of the present invention. Such a window molding assembly installation is accomplished according to the present invention by providing a preassembled box frame 54 having a right side, left side, top side and window sill. The right side, left side, top side and a portion of the window sill is configured to fit within the window opening 52. The preassembled box frame 54 has a plurality of decorative molding pieces, such as header molding 56 and apron molding 58, attached to the front of the box frame 54. These pieces 56 and 58 extend outwardly therefrom in a lateral direction in order to cover the edges 60 and 62 of the window opening 52. The box frame 54 is insert into the interior window opening 52 and fixedly attached thereto, as with fasteners and/or adhesives.

As shown, the window opening 52 is defined by the framing header 64, typically of 2×4 or 2×6 construction. Sheet Rock 66 is applied to the front of the header 64 and defines the inner wall surface. Likewise, the bottom of the window opening 52 is framed with a 2×4 or 2×6 member 68 and is covered with Sheet Rock 70. A window 72 is attached within the window opening 52 and is often covered around its edges with the exterior surface material of the structure, such as stucco 74. The window 72 thus sits nearer to the exterior surface of the structure such that an interior window opening 52 having a depth D is formed. The width W of the box frame 54 is configured to substantially match the depth D of the window opening 52 so that the box frame 54 abuts or nearly abuts the inside surface 78 of the window. As such, the box frame 54 completely covers the inside surfaces of the window opening 52 and the molding pieces 56 and 58 abut against the inside wall of the structure and cover the front edges of the window opening 52. In addition, the height H1 and H2 of the top and bottom frame members 55 and 57, respectively, are less than or equal to the respective heights of the interior surfaces 78 and 79. This is also true for the side molding pieces, such as side 54. As such, the exposed side end surfaces of the molding pieces that abut against the window frame 63 are covered by the window frame 63 such that the exposed side end surfaces are not visible from outside the window and the window molding assembly 50 has a finished appearance. Accordingly, after installation of the window 72 no finish work to the inside surfaces of the window opening 52 are required since all unfinished surfaces are completely covered by the window molding assembly 50 of the present invention.

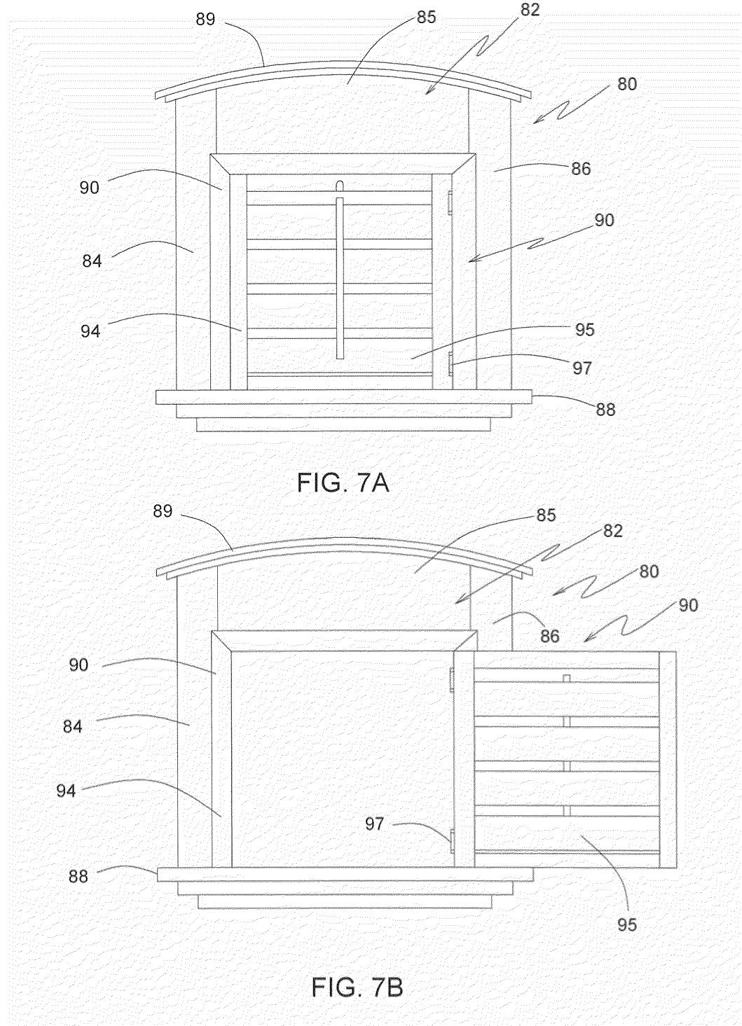

As illustrated in FIGS. 7A-9B, various embodiments of a decorative window molding assembly are illustrated. In FIGS. 7A and 7B, the window molding assembly, generally indicated at 80, is comprised of a decorative front fascia 82 comprised of side members 84 and 86, a top member 85 and a sill 88. Arched trim pieces 89 cap the top edges of the side members 84 and 86 and the top member 85. The window molding assembly 80 is configured to fit within and mount to a window opening as has been previously described herein. A window shutter assembly 90 is attached to the front fascia 82. The shutter assembly 90 is comprised of a three sided frame 92 to which a shutter 94 having pivotal louvers 95 are attached. The shutter 94 is hingedly attached, as with hinges 97 to the frame 92 so as to allow the shutter 94 to be opened as shown in FIG. 7B.

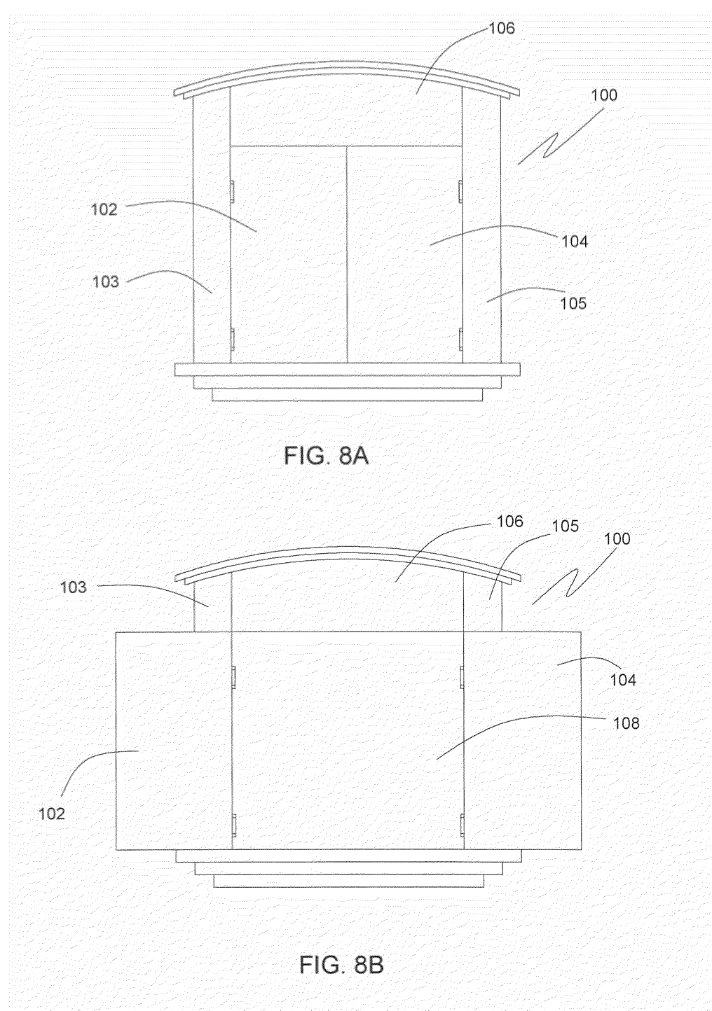

As shown in FIGS. 8A and 8B, a decorative window molding, generally indicated at 100, is illustrated. The window molding 100 is configured similarly to the window molding assembly 80 illustrated in FIG. 7A except that the window molding is provided with a pair of doors 102 and 104 attached to the left and right side members 103 and 105, respectively, of the front fascia 106. Thus, rather than having a shutter assembly attached as illustrated in FIG. 7A, the doors 102 and 104 can be opened to expose the window 108.

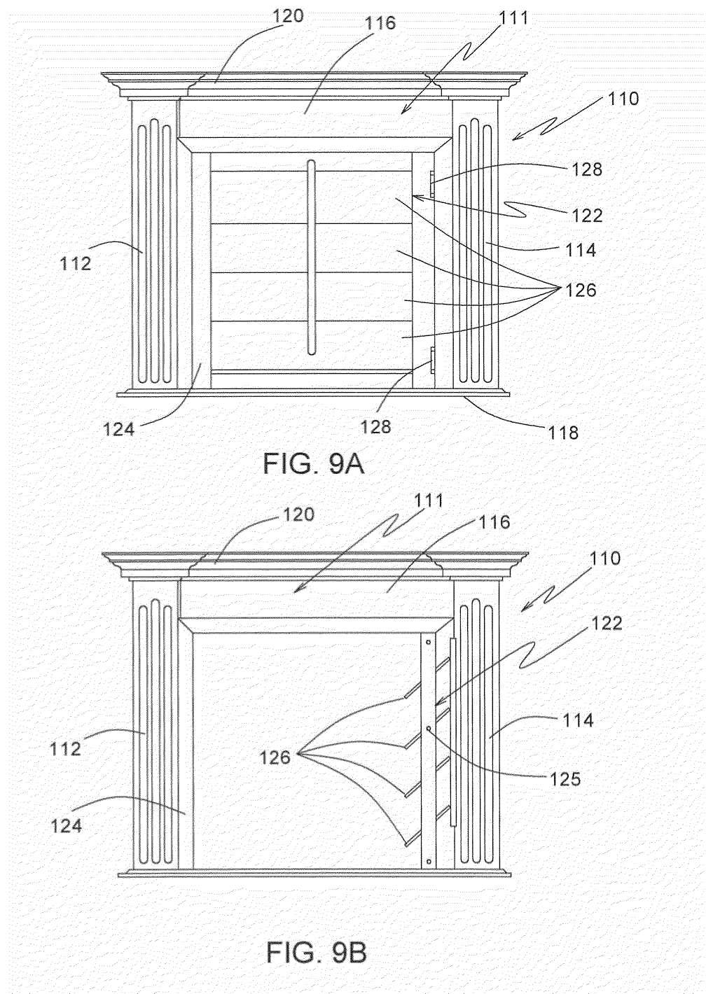

As further illustrated in FIGS. 9A and 9B, a window molding assembly, generally indicated at 110, is configured with decorative front fascia 111 comprised of side members 112 and 114, top member 116, sill member 118 and decorative top trim pieces 120. A shutter assembly, generally indicated at 122, is attached to the front fascia 111. The shutter assembly 122 is comprised of a rectangular frame 124 having top, bottom and side members to which louvers 126 are pivotally attached. A louver control rod 128 is coupled to each of the louvers 126 so as to simultaneously open and close the louvers as by raising and lowering the control rod 128. The louvers 126 are pivotally coupled to the frame 124 with pins 125 that extend from each louver into a bore in the frame 124 to allow the louvers 126 to pivot relative to the frame. The frame 124 is hingedly coupled to the window molding assembly 110 as with hinges 128.

In order to install a window molding assembly according to the present invention as herein described, the measurements of a window opening to which the window molding assembly is to be installed are taken. The measurements include the height, width and depth of the window opening. In addition, because the window opening may not be necessarily square (i.e., the height, width and/or depth of the window opening may not be uniform along the entire relative distance) the height, width and depth of each window opening may be taken at more than one location, such as at each end and in the middle of each. That way, the window molding assembly of the present invention can be made to fit the particular window opening. Because, however, each installed window is typically square (i.e., each corner of the window forms a 90 degree angle for a rectangular-shaped window), it is desirable to form the window molding assembly to also be square even if the window opening is not exactly square. Thus, the window molding assembly of the present invention can correct defects in construction that often occur.

Once the measurements are taken, the components of the box frame are cut to form a box frame that will fit within the window opening and abut or be adjacent to the frame of the window. Because the window molding assembly of the present invention is prefabricated and delivered fully assembled to the job site, the pieces may be cut using precision and even automated cutting tools, such as those found in cabinet manufacturing facilities so that the finished product meets tight tolerance specifications that are not generally achievable if such a product were manufactured and attached to the window opening piece by piece at a job site using ordinary hand tools. Once the box frame pieces are cut, they are assembled as shown in FIGS. 2, 3 and 4. As shown in FIG. 5, depending on the style and design of the particular window molding assembly, the components of the front fascia are cut and assemble to the box frame. Any additional decorative trim pieces are then attached to the front fascia and sill member if desired. If desired, a shutter assembly or doors may be attached to the front fascia. Each individual subassembly can be pre-stained and pre-varnished or pre-painted or the finished window molding assembly can be stained and varnished or painted as may be desired.

Once complete, the window molding assembly is boxed and shipped to the job site. Once received, the window molding assembly is simply inserted into the window opening so that the back side of the front fascia abuts against the surrounding wall and the box frame is inserted into the window opening. The window molding assembly can then be secured to the window opening with air driven nails and/or construction adhesive so as to attach the window molding assembly to the window opening. Likewise, the window molding assembly may be screwed to the window opening. Using screws allows the window molding assemblies to be easily removed from the window opening if a different style of window opening treatment is later desired or if a window molding assembly of the present invention is somehow damaged and needs replacement.

While the apparatuses and methods of the present invention have been described with reference to certain illustrative embodiments to show what is believed to be the best mode of the invention, it is contemplated that upon review of the present invention, those of skill in the art will appreciate that various modifications and combinations of the various embodiments may be made to the present embodiments without departing from the spirit and scope of the invention as recited in the claims. Reference herein to specific details of the illustrated embodiments is by way of example and not by way of limitation.

What is claimed is:

1. A window molding assembly, comprising:
a box frame having a right side, left side, top side and window sill, the right side, left side, top side and a portion of the window sill configured to fit within a window opening; and
a plurality of decorative molding pieces attached to the front of the right side, left side and top side and extending outwardly therefrom in a lateral direction to form a front fascia to cover a front edge of a window opening.

2. The window molding assembly of claim 1, wherein said window sill comprises a first more narrow portion that is configured to fit within a window opening adjacent a bottom of said window opening and a second wider portion that is wider than the window opening adjacent the bottom of the window opening to extend laterally from said window opening on both sides thereof.

3. The window molding assembly of claim 1, wherein said front fascia is comprised of left and right vertical side members and a horizontal top member extending to and between said left and right vertical side members, an opening defined by said front fascia being approximately equal to an opening defined by said box frame.

4. The window molding assembly of claim 1, further comprising at least one shutter assembly attached to said fascia, said at least one shutter assembly substantially covering an opening defined by said front fascia.

5. The window molding assembly of claim 1, wherein said box frame is sized to just fit within a window opening, wherein the window opening is not square and said box frame is precisely square.

6. The window molding assembly of claim 1, wherein said window opening is an unfinished window opening.

7. The window opening of claim 1, wherein said left side, right side, top side and window sill have widths that substantially match a depth of a window opening so that the box frame resides entirely within said window opening.

8. The window molding assembly of claim 7, wherein each inside edge of each of said left side, right side, top side and sill is adjacent to a frame of an associated window when installed therein.

9. A method of installing a window molding assembly, comprising:
providing a preassembled box frame having a right side, left side, top side and window sill, the right side, left side, top side and a portion of the window sill configured to fit within a window opening, the preassembled box frame having a plurality of decorative molding pieces attached to the front of the right side, left side and top side and extending outwardly therefrom in a lateral direction to form a front fascia, the box frame and front fascia forming a decorative window molding assembly;
inserting the box frame into an interior window opening; and
attaching the box frame to the interior window opening.

10. The method of claim 9, wherein said attaching comprises removably attaching the box frame to the interior window opening.

11. The method of claim 9, further comprising measuring the height, width and depth of a window opening.

12. The method of claim 11, further comprising forming the right side, left side, top side based on the measured height, width and depth and assembling the right side, left side, top side and window sill to form the box frame that will just fit within the window opening.

13. The method of claim 12, further comprising sizing said box frame to just fit within a window opening, wherein the window opening is not square and said box frame is substantially precisely square.

14. The method of claim 9, further comprising installing said window molding assembly to an unfinished window opening.

15. The method of claim 9, further comprising forming said left side, right side, top side and window sill have to have widths that substantially match a depth of a window opening so that the box frame resides entirely within the window opening.

16. The method of claim 15, further comprising inserting each inside edge of each of said left side, right side, top side and sill adjacent to a frame of an associated window.

17. The method of claim 9, further comprising manufacturing a shutter assembly sized to substantially match an opening defined by said box frame and attaching the shutter assembly to the front fascia.
